(19) United States
(12) Patent Application Publication
(10) Pub. No.: US 2010/0010689 A1
(43) Pub. Date: Jan. 14, 2010

(54) DRUNKEN DRIVING PREVENTION DEVICE, DRUNKEN DRIVING PREVENTION METHOD, AND DRUNKEN DRIVING PREVENTION PROGRAM

(75) Inventors: Mitsuo Yasushi, Saitama (JP); Masatoshi Yanagidaira, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/526,152

(22) PCT Filed: Feb. 7, 2007
(86) PCT No.: PCT/JP2007/052110

§ 371 Date: Sep. 11, 2009

(51) Int. Cl. B60K 28/06

(52) U.S. Cl. 701/1

(57) ABSTRACT

A drunken driving prevention device having an alcohol sensor and being mounted on a vehicle including an automobile includes a judging element for judging whether inspection for detecting alcohol via the alcohol sensor should be performed or not based on predetermined conditions when the vehicle is started. The drunken driving prevention device further includes an element for performing the inspection via the alcohol sensor when the judging element judges to perform inspection, and a control element for disabling operation of the vehicle if alcohol is detected as a result of the inspection.

### TECHNICAL FIELD

The present invention relates to a technique of preventing a drunk driving by utilizing a navigation apparatus.

### BACKGROUND TECHNIQUE

A drunk driving of a vehicle such as an automobile is prohibited by law such as Road Traffic Law. Therefore, there has been developed an apparatus by which a driver measures the breath alcohol concentration by breathing out to the alcohol sensor before driving and the driving is prevented if the alcohol concentration higher than a predetermined level is detected (For example, the patent Reference-1).

In such a conventional apparatus, the test of measuring alcohol concentration is carried out every time before driving the vehicle, there is such a problem that some driver feel the test troublesome.

Patent Reference-1: Japanese Patent Application Laid-open under No. 2005-224319

### DISCLOSURE OF INVENTION

### Problem to be Solved by the Invention

The above is one example of problems to be solved by the present invention. It is an object of this invention to provide a drunk driving preventing apparatus capable of accurately determining a situation in which the test is unnecessary, in consideration of drunk persons on the back seats, thereby to avoid unnecessary alcohol detecting test performed when the driver is obviously not drinking alcohol.

### Means for Solving the Problem

An invention described in claim 1 is a drunk driving preventing apparatus installed on a vehicle and including an alcohol sensor, including: a test determining unit which determines whether or not to perform a test for detecting alcohol by the alcohol sensor, based on a predetermined condition, when the vehicle is started; a test performing unit which performs the test by the alcohol sensor when the test determining unit determines to perform the test; and a control unit which disables driving operation of the vehicle when the test performing unit performs the test and alcohol is detected as a result of the test.

An invention described in claim 9 is a drunk driving preventing method executed by a drunk driving preventing apparatus installed on a vehicle and including an alcohol sensor, including: a test determining process which determines whether or not to perform a test for detecting alcohol by the alcohol sensor, based on a predetermined condition, when the vehicle is started; a test performing process which performs the test by the alcohol sensor when the test determining process determines to perform the test; and a control process which disables driving operation of the vehicle when the test performing process performs the test and alcohol is detected as a result of the test.

An invention described in claim 10 is a drunk driving preventing program executed by a computer installed on a vehicle and including an alcohol sensor, the program makes the computer function as: a test determining unit which determines whether or not to perform a test for detecting alcohol by the alcohol sensor, based on a predetermined condition, when the vehicle is started; a test performing unit which performs the test by the alcohol sensor when the test determining unit determines to perform the test; and a control unit which disables driving operation of the vehicle when the test performing unit performs the test and alcohol is detected as a result of the test.

### BRIEF DESCRIPTION OF THE DRAWINGS

FIG. 1 is a block diagram showing a configuration of a navigation apparatus according to an embodiment;

FIG. 2 is a block diagram showing a basic configuration of a drunk driving preventing apparatus;

FIG. 3 is a functional block diagram of the drunk driving preventing apparatus;

FIG. 4 is a flowchart of a drunk driving preventing process; and

FIG. 5 is a block diagram showing a configuration of a drunk driving preventing apparatus according to a modified embodiment.

### DESCRIPTION OF THE REFERENCE NUMBER

10 Stand-alone position measurement device
18 GPS receiver
20 System controller
22 CPU
36 Data storage unit
40 Display unit
60 Input device
100 Navigation apparatus
110 Alcohol Sensor
120 Drunk Driving Control device
130 Engine Starting Device
200 Drunk Driving preventing apparatus

### BEST MODE FOR EXERCISING THE INVENTION

According to one aspect of the present invention, there is provided a drunk driving preventing apparatus installed on a vehicle and including an alcohol sensor, including: a test determining unit which determines whether or not to perform a test for detecting alcohol by the alcohol sensor, based on a predetermined condition, when the vehicle is started; a test performing unit which performs the test by the alcohol sensor when the test determining unit determines to perform the test; and a control unit which disables driving operation of the vehicle when the test performing unit performs the test and alcohol is detected as a result of the test.

The above-described drunk driving preventing apparatus includes an alcohol sensor and is installed in a vehicle such as an automobile. The alcohol sensor is a sensor which can detect alcohol included in breath or blood of a driver, or in the air. When the driver starts the vehicle, i.e., before the driver drives the vehicle, the drunk driving preventing apparatus installed in the vehicle determines whether or not to perform a test for detecting alcohol by an alcohol sensor, based on a predetermined condition. If alcohol is detected as a result of the test performed, the drunk driving preventing apparatus disables the driving operation of the vehicle. As a method of disabling the driving operation of the vehicle, there is a method of interrupting or stopping the supply of fuel or electric power to the engine to disable the start of the vehicle, or a method of locking the door not to open. Thus, since the drunk driving preventing apparatus can determine whether or not to perform the test for detecting alcohol based on the predetermined condition, it is possible to omit unnecessary test in such a situation that the driver is obviously not drinking alcohol.

In one manner of the above drunk driving preventing apparatus, the test performing unit performs the test by measuring an alcohol concentration by the alcohol sensor when the test determining unit determines to perform the test, and the control unit disables the driving operation of the vehicle when the test performing unit performs the test and the alcohol concentration measured by the alcohol sensor is equal to or higher than a predetermined threshold value. By this, the driving operation of the vehicle is disabled, not in a case that alcohol is simply detected, but only in a case that the measured alcohol concentration is equal to or higher than the predetermined threshold value. Specifically, when the threshold value is set to “0.15 mg” at which the driver is judged to be drinking alcohol according to Road Traffic Law, the driver can start the vehicle if the alcohol sensor concentration measured by the alcohol sensor is “0.03 mg”. Therefore, it becomes possible to solve such a problem that the driver is not drinking alcohol but very small amount of alcohol is detected for some causes.

In another manner, the above drunk driving preventing apparatus further includes: a specific position storing unit which stores a position of a specific place; and a vehicle stopped position obtaining unit which obtains a vehicle stopped position, wherein the test determining unit determines whether or not to perform the test based on the vehicle stopped position obtained by the vehicle stopped position obtaining unit and the position of the specific place stored by the specific position storing unit, when the vehicle is started. Here, the specific place may be a “workplace” wherein drinking alcohol is done with low possibility, or a “bar” to the contrary where drinking alcohol is done with high possibility, for example, and it may be arbitrarily determined. By this, the drunk driving preventing apparatus can determine whether or not to perform the test for detecting alcohol based on a specific place where drinking alcohol is done with low possibility or a specific place where drinking alcohol is done with high possibility. Namely, the drunk driving preventing apparatus can necessarily perform the test in a case that the drinking alcohol is done with high possibility, and can omit the test in a case that obviously drinking alcohol is not done. Therefore, the drunk driving preventing apparatus can accurately determine, based on the place, such a situation that the test is unnecessary.

In another manner, the above drunk driving preventing apparatus further includes: a specific time storing unit which stores a specific time; and a present time obtaining unit which obtains a present time, wherein the test determining unit determines whether or not to perform the test based on the present time obtained by the present time obtaining unit and the specific time stored by the specific time storing unit, when the vehicle is started. Here, the specific time may be “AM 9:00 to PM 4:00” at which drinking alcohol is done with low possibility, or “PM 6:00 to AM 6:00”, to the contrary, at which drinking alcohol is done with high possibility, for example, and it may be arbitrarily determined. By this, the drunk driving preventing apparatus can determine whether or not to perform test for detecting alcohol based on the time at which drinking alcohol is done with low possibility or the time at which drinking alcohol is done with high possibility. Therefore, the drunk driving preventing apparatus can accurately determine, based on the time, such a situation that the test is unnecessary.

In another manner, the above drunk driving preventing apparatus further includes: a vehicle stopped time storing unit which stores a vehicle stopped time; and a vehicle stopping time period determining unit which determines a vehicle stopping time period by calculating a difference between the present time obtained by the present time obtaining unit and the vehicle stopped time stored by the vehicle stopped time storing unit, wherein the test determining unit determines whether or not to perform the test if the vehicle stopping time period determined by the vehicle stopping time period determining unit is equal to or longer than a predetermined time period, when the vehicle is started. Here, the predetermined time period may be “1 hour” which is too short for a person to drink alcohol, for example, and it may be arbitrarily determined. By this, the drunk driving preventing apparatus can determine not to perform the test for detecting alcohol if the vehicle stopping time period is shorter than the time period which is too short for a person drink alcohol. Therefore, the drunk driving preventing apparatus can accurately determine, based on the vehicle stopping time period, such a situation that the test is unnecessary.

In another manner of the above drunk driving preventing apparatus, the alcohol sensor includes: simple alcohol sensors installed at a driver's seat and a rear seat of the vehicle, respectively, and capable of detecting alcohol; and a measuring alcohol sensor installed at the driver's seat and capable of measuring an alcohol concentration. The drunk driving preventing apparatus further includes a simple detecting unit which detects alcohol near the driver's seat and alcohol near the rear seat, respectively, by the simple alcohol sensors. The test determining unit determines whether or not to perform the test based on a detection result of alcohol near the driver's seat and a detection result of alcohol near the rear seat by the simple alcohol sensors, and the test performing unit performs the test by measuring the alcohol concentration by the measuring alcohol sensor when the test determining unit determines to perform the test.

The above drunk driving preventing apparatus includes a plurality of alcohol sensors, and each of the alcohol sensors is installed in the vehicle. The simple alcohol sensor capable of detecting alcohol near the driver's seat and the measurement alcohol sensor capable of detecting alcohol concentration are installed at the driver's seat. On the other hand, the simple alcohol sensor capable of detecting alcohol near the rear seat is installed at the rear seat. The drunk driving preventing apparatus determines whether or not to perform a strict test for measuring alcohol concentration by the measurement alcohol sensor, based on the alcohol detection result near the driver's seat and the alcohol detected result near the rear seat by the simple alcohol sensors. Thus, by determining whether or not to perform the strict alcohol test based on the detection results of the plural alcohol sensors installed in each position in the vehicle, it can be possible accurately determine such a situation that the test is unnecessary.

In another manner of the above drunk driving preventing apparatus, the control unit disables the driving operation of the vehicle without performing the test by the test performing unit, when the simple detecting unit detects alcohol near the driver's seat and does not detect alcohol near the rear seat. By this, when the alcohol is detected only near the driver's seat, the drunk driving preventing apparatus judges that the driver is drinking alcohol with high possibility and disables the driving operation of the vehicle. Namely, since the strict test by the measurement alcohol, sensor is omitted, driving the vehicle by the drunk driver can be quickly prevented.

In another manner of the above drunk driving preventing apparatus, the test determining unit determines to perform the test when the simple detecting unit detects weak alcohol near the driver's seat and detects strong alcohol near the rear seat. When strong alcohol is detected near the rear seat and weak alcohol is detected near the driver's seat, it is higher possible that the passenger on the rear seat is drinking alcohol and the alcohol is flowing and reaching the driver's seat. Namely, it is possible that the driver is not drinking alcohol. The drunk driving preventing apparatus performs the strict test by the measurement alcohol sensor before disabling the driving operation of the vehicle. Therefore, the drunk driving preventing apparatus can determine such a situation that the test is unnecessary, in consideration of alcohol-drinking person sitting on the rear seat.

According to another aspect of the present invention, there is provided a drunk driving preventing method executed by a drunk driving preventing apparatus installed on a vehicle and including an alcohol sensor, including: a test determining process which determines whether or not to perform a test for detecting alcohol by the alcohol sensor, based on a predetermined condition, when the vehicle is started; a test performing process which performs the test by the alcohol sensor when the test determining process determines to perform the test; and a control process which disables driving operation of the vehicle when the test performing process performs the test and alcohol is detected as a result of the test.

By performing this method on the drunk driving preventing apparatus, it is possible to determine whether or not to perform the test for detecting alcohol based on a predetermined condition, and hence it is possible to omit unnecessary test in such a situation that obviously the driver is not drinking alcohol.

According to still another aspect of the present invention, there is provided a drunk driving preventing program executed by a computer installed on a vehicle and including an alcohol sensor, the program makes the computer function as: a test determining unit which determines whether or not to perform a test for detecting alcohol by the alcohol sensor, based on a predetermined condition, when the vehicle is started; a test performing unit which performs the test by the alcohol sensor when the test determining unit determines to perform the test; and a control unit which disables driving operation of the vehicle when the test performing unit performs the test and alcohol is detected as a result of the test. By executing the program by the computer, the above drunk driving preventing apparatus can be realized. Namely, since it is possible to determine whether or not to perform the test for detecting alcohol based on a predetermined condition, it is possible to omit unnecessary test in such a situation that obviously the driver is not drinking alcohol. The program may be used in a manner being stored in a storage medium.

### Embodiment

Now, a description will be given of a preferred embodiment of the present invention with reference to attached drawings. The following explanation shows such an example that the present invention is applied to an on-vehicle navigation apparatus.

(Navigation Apparatus)

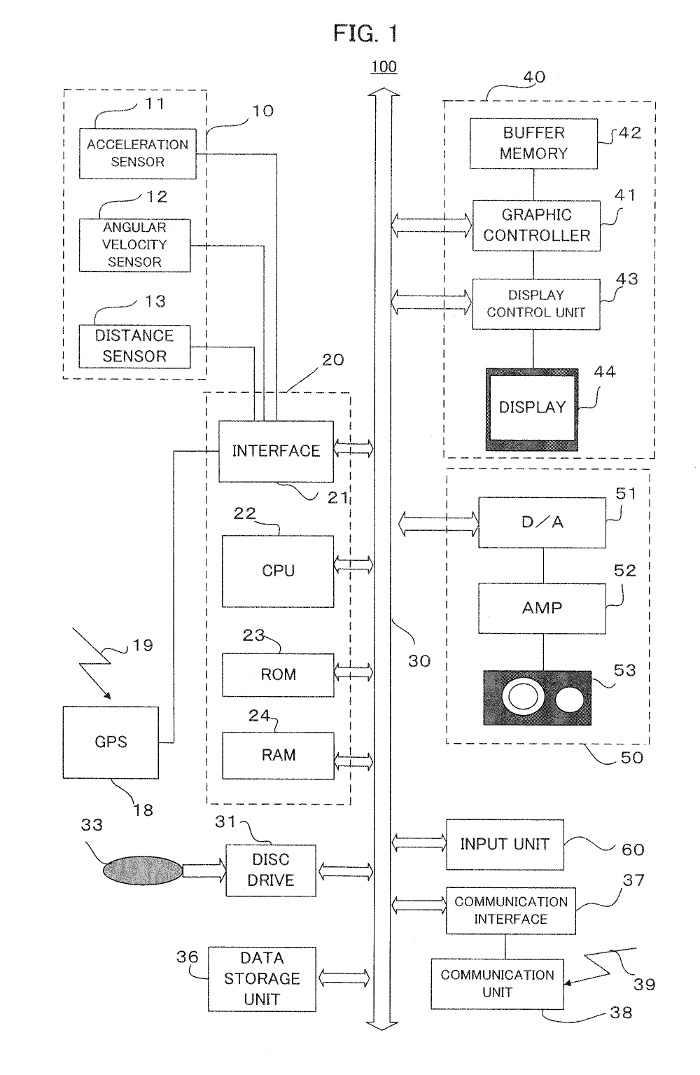

FIG. 1 shows a configuration of a navigation apparatus 100 according to an embodiment of the present invention. As shown in FIG. 1, the navigation apparatus 100 includes a stand-alone position measurement device 10, a GPS receiver 18, a system controller 20, a disc drive 31, a data storage unit 36, a communication interface 37, a communication device 38, a display unit 40, a sound output unit 50, and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated with the wheel rotation of the vehicle.

The GPS receiver 18 receives an electric wave 19 for sending downlink data including position measurement data from plural GPS satellites. The position measurement data is used for detecting the absolute position of the vehicle from longitude and latitude information.

The system controller 20 includes an interface 21, a CPU 22, a ROM 23 and a RAM 24, and controls the entire navigation apparatus 100.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 may be the CD-ROM drive or the DVD-ROM drive, or may be a drive compatible between the CD and the DVD.

The data storage unit 36 includes HDD, for example, and stores various kinds of data used for a navigation process such as map data and facility data.

The communication device 38 includes an FM tuner, a beacon receiver, a mobile phone and a dedicated communication card, for example, and obtains road traffic information such as traffic jam and traffic information and other information, delivered from a VICS (Vehicle Information Communication System) center via the communication interface 37.

The display unit 40 displays various kinds of display data on a display device such as a display under the control of the system controller 20. Concretely, the system controller 20 reads the map data from the data storage unit 36. The display unit 40 displays, on a display screen such as a display, the map data read from the data storage unit 36 by the system controller 20. The display unit 40 includes a graphic controller 41 for controlling the entire display unit 40 on the basis of the control data sent from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A conversion of the sound digital data sent from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of the display 44 and a front panel of a main body of an on-vehicle electric system loaded on the vehicle. Additionally, in such a case that the display 44 is in a touch panel system, a touch panel provided on the display screen of the display 44 functions as the input device 60, too.

(Method of Preventing Drunk Driving)

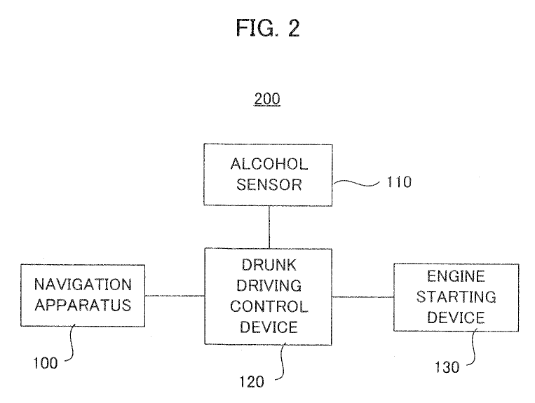

Next, the description will be given of a method of preventing a drunk driving by utilizing the navigation apparatus 100. FIG. 2 is a block diagram showing a basic configuration of a drunk driving preventing apparatus 200 which executes the drunk driving preventing process in this embodiment. As shown in FIG. 2, the drunk driving preventing apparatus 200 includes a navigation apparatus 100, an alcohol sensor 110, a drunk driving control device 120 and an engine stating device 130.

The alcohol sensor 110 can measure breath alcohol concentration when a driver breathes out to the alcohol sensor 110. Although the detail will be described later, when receiving the test signal from the drunk driving control device 120, the alcohol sensor 110 measures the alcohol concentration of driver's breath and sends the measurement result to the drunk driving control device 120.

In this embodiment, an alcohol sensor capable of measuring the breath alcohol concentration is used as the alcohol sensor 110, but the present invention is not limited to this. An alcohol sensor having a gas volume sensor to detect the breath of the driver, or an alcohol sensor capable of measuring alcohol concentration, not in the breath, but in the sweat may be used. Namely, any kind of alcohol sensor can be used. The method of measuring the alcohol concentration by various kinds of alcohol sensors is well known, and hence the explanation will be omitted for the sake of convenience.

The drunk driving control device 120 has a memory for storing a criterion information which shows a criterion to determine the necessity of the alcohol concentration measuring test. Specifically, the criterion information may include a position data indicating a specific place where the test is omitted (exempted), and a specific time. The position data indicating a specific place where the test is omitted may be a position data indicating “workplace” where generally people do not drink alcohol, or a position data indicating “home” where driving is not needed after drinking, and it can be arbitrarily set. Meanwhile, the specific time is a time when drinking alcohol is highly possible, and it may be arbitrarily set to “From PM 6:00 to AM 6:00”, for example.

Further, the drunk driving control device 120 obtains the current position data by the GPS indicating the current position from the navigation apparatus 100, and stores the vehicle stopped position data indicating the place where the vehicle stopped when the vehicle stopped. Also, the drunk driving control device 120 obtains the present time from the navigation apparatus 100, and stores the vehicle stopped time in the memory when the vehicle stopped.

When the vehicle being stopped is started, i.e., the driver starts driving the vehicle, the drunk driving control device 120 determines whether or not to perform the test for measuring the alcohol concentration by referring to the criterion information based on the vehicle stopped position data, the vehicle stopped time and the present time.

The first method of determining the necessity of the test is to compare the vehicle stopped position data with the position data indicating the specific place included in the criterion information, and determine that the test is not necessary if the vehicle stopped position is the place where the test is omitted. In this case, if the vehicle stopped position is not the place where the test is omitted, it is determined that the test is necessary, and the alcohol sensor 110 measures the alcohol concentration.

The second method of determining the necessity of the test is to compare the present time when the vehicle is started with the specific time included in the criterion information, and determines that the test is not necessary if the present time is not the specific time. In this case, if the present time is the specific time, it is determined that the test is necessary, and the alcohol sensor 110 measures the alcohol concentration. It is note that, in the case where a specific time zone is stored as the criterion information, the drunk driving control device 120 determines that the test is not necessary if the present time does not belong to the specific time zone.

The third method of determining the necessity of the test is to specify the vehicle stopping time period by calculating the difference between the present time when the vehicle is started and the vehicle stopped time, and determine that the test is not necessary if the vehicle stopping time period is shorter than a predetermined time period. In this case, if the vehicle stopping time period is longer than the predetermined time period, it is determined that the test is necessary, and the alcohol sensor 110 measures the alcohol concentration. The predetermined time period is a time period which is too short to drink alcohol, for example 1 hour, and it may be arbitrarily set.

The drunk driving control device 120 determines the necessity of the test measuring the alcohol concentration in the above-mentioned methods, and sends the test signal to the alcohol sensor 110 and warns the driver to do the test when it is determined that the test is necessary.

After sending the test signal, the drunk driving control device 120 obtains the driver's breath alcohol concentration as the test result from the alcohol sensor 110. Then, the drunk driving control device 120 compares a predetermined alcohol concentration (hereinafter referred to as “threshold”) with the driver's breath alcohol concentration, and sends the start permission signal to the engine starting device 130 if the driver's breath alcohol concentration is lower. On the other hand, when the driver's breath alcohol concentration is higher, the drunk driving control device 120 sends the start inhibition signal. The predetermined alcohol concentration is a concentration used as criteria to determine whether or not the vehicle is started, namely a concentration used as criteria to determine whether or not the driver is drunk, and it may be arbitrarily set to “0.15 mg” at which the driver is judged as low-level drunk driving according to Road Traffic Law.

The engine starting device 130 starts the engine to start the vehicle when it receives the start permission signal from the drunk driving control device 120. On the other hand, the engine starting device 130 does not start the vehicle by interrupting or stopping the supply of fuel or electric power to the engine when it receives the start inhibition signal from the drunk driving control device 120.

In this way, since the engine is not started based on the signal received from the drunk driving control device 120, the driving is prevented when the driver's breath alcohol concentration is equal to or higher than the predetermined threshold. Also, it is possible to determine the necessity of the test of measuring the alcohol concentration based on the predetermined place, time and vehicle stopping time period. Therefore, it is possible to omit the unnecessary test of breathing out to the alcohol sensor 110 in such a situation that obviously the driver is not drinking alcohol.

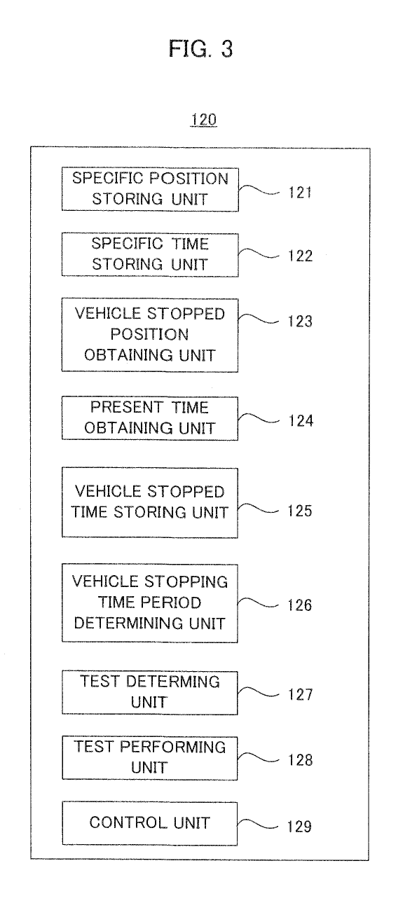

The functions of the drunk driving control device 120 will be described in detail with reference to FIG. 3. FIG. 3 is a functional block diagram showing major configuration of the drunk driving control device 120.

As shown in FIG. 3, the drunk driving control device 120 functionally includes a specific position storing unit 121, a specific time storing unit 122, a vehicle stopped position obtaining unit 123, a present time obtaining unit 124, a vehicle stopped time storing unit 125, a vehicle stopping time period determining unit 126, a test determining unit 127, a test performing unit 128 and a control unit 129.

The specific position storing unit 121 stores, in the memory, the position data indicating the specific place where the test is omitted, as the criterion information used as criterion of determining the necessity of the test of measuring the alcohol concentration. The specific position storing unit 121 functions as a specific position storing means according to the present invention.

The specific time storing unit 122 stores, in the memory, the time when the drinking alcohol is highly possible, as the criterion information used as criterion of determining the necessity of the test of measuring alcohol concentration. The specific time storing unit 122 functions as a specific time storing means according to the present invention.

The vehicle stopped position obtaining unit 123 obtains the vehicle stopped position data indicating the vehicle stopped position from the navigation apparatus 100. Specifically, the vehicle stopped position obtaining unit 123 obtains the current position data by GPS indicating the current position from the navigation apparatus 100, and stores the vehicle stopped position data in the memory when the vehicle stops. The vehicle stopped position obtaining unit 123 functions as a vehicle stopped position obtaining means according to the present invention.

The present time obtaining unit 124 obtains the present time from the navigation apparatus 100. The present time obtaining unit 124 functions as a present time obtaining means according to the present invention.

The vehicle stopped time storing unit 125 stores the vehicle stopped time when the vehicle stopped. The vehicle stopped time storing unit 125 functions as a vehicle stopped time storing means according to the present invention.

The vehicle stopping time period determining unit 126 determines the vehicle stopping time period by calculating the difference between the present time that the present time obtaining unit 124 obtained and the vehicle stopped time that the vehicle stopped time storing unit is storing. The vehicle stopping time period determining unit 126 functions as a vehicle stopping time period determining means according to the present invention.

The test determining unit 127 determines whether or not to perform the test of measuring the alcohol concentration by the alcohol sensor 110, based on a predetermined condition, at the time when the driver starts the vehicle, i.e., before the driver starts driving the vehicle. Specifically, as the first method, the test determining unit 127 compares the vehicle stopped position data obtained by the vehicle stopped position obtaining unit 123, with the position data indicating the specific place and stored in the specific position storing unit 121, and determines that the test is not necessary if the vehicle stopped position is a place where the test is omitted. As the second method, the test determining unit 127 compares the present time that the present time obtaining unit 124 obtains when the vehicle is started, with the specific time that the specific time storing unit 122 is storing, and determines that the test is not necessary if the present time is not the specific time. As the third method, the test determining unit 128 determines that the test is not necessary if the vehicle stopping time period that the vehicle stopping time period determining unit 126 determined at the time of starting the vehicle is shorter than the predetermined time period. The test determining unit 127 functions as a test determining means according to the present invention.

The test performing unit 128 performs the test of measuring the alcohol concentration by the alcohol sensor 110 if the test determining unit determines that the test is necessary. Specifically, the test performing unit 128 performs the test by sending the test signal to the alcohol sensor 110. The test performing unit 128 functions as a test performing means according to the present invention.

The control unit 129 performs the control of disabling the driving operation of the vehicle based on the test result by the test performing unit 128. Specifically, if the driver's breath alcohol concentration, which is the test result, is higher than the predetermined threshold, the control unit 129 sends the start inhibition signal to the engine starting device 130 to disable the driving operation of the vehicle. On the other hand, if the driver's breath alcohol concentration, which is the test result, is lower than the predetermined threshold, the control unit 129 sends the start permission signal to the engine starting device 130 to enable the driving operation of the vehicle. The control unit 129 functions as a control means according to the present invention.

It is noted that the above-mentioned elements are realized by the CPU of the drunk driving control device 120 which executes the program prepared in advance.

(Drunk Driving Preventing Process)

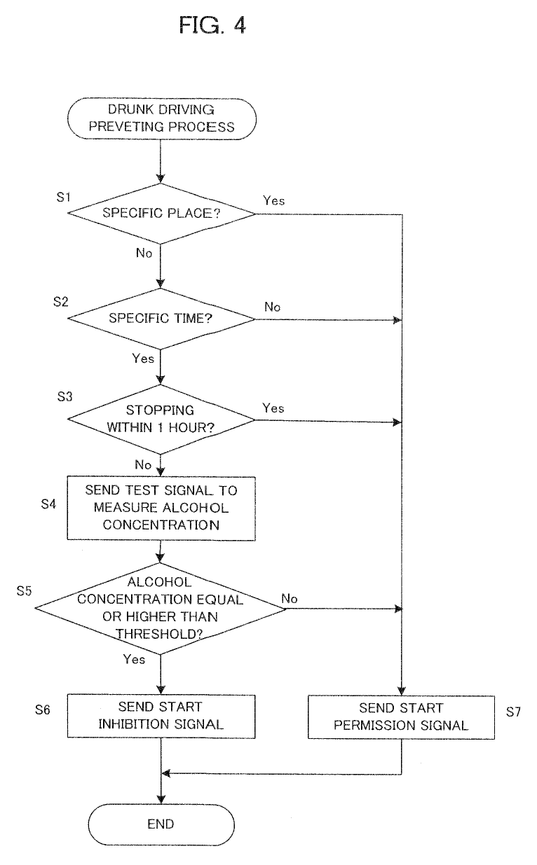

Next, the drunk driving preventing process will be described. FIG. 4 is a flowchart of the drunk driving preventing process according to this embodiment. The drunk driving preventing process as shown is realized by the CPU of the drunk driving control device 120 executing a program prepared in advance.

When the driver tries to start the vehicle, the test determining unit 127 of the drunk driving control device 120 refers to the criterion information based on the vehicle stopped position data stored in the memory and determines whether or not the stopped position of the vehicle is the specific place (step S1). If the stopped position of the vehicle is the specific place (step S1; Yes), the test determining unit 127 determines that the test is not necessary. Then, the control unit 129 sends the start permission signal to the engine starting device 130 (step S7). On the other hand, if the stopped position of the vehicle is not the specific place (step S1; No), the test determining unit 127 refers to the criterion information based on the present time that the present time obtaining unit 124 obtains from the navigation apparatus 100, and determines whether or not the present time is the specific time (step S2). If the present time, i.e., the driving start time at which the vehicle is started, is not the specific time (step S2; No), the test determining unit 127 determines that the test is not necessary. Then, the control unit 129 sends the start permission signal to the engine starting device 130 (step S7).

On the other hand, if the present time, i.e., the vehicle starting time, is the specific time (step S2; Yes), the test determining unit 127 determines whether or not the vehicle stopping time period, which the vehicle stopping time period determining unit 126 determined by calculating the difference between the vehicle stopped time stored in the memory and the present time, is within the predetermined time period (step S3). In this embodiment, the predetermined time period is “1 hour”. If the vehicle stopping time period is within 1 hour (step S3; Yes), the test determining unit 127 determines that the test is not necessary. Then, the control unit 129 sends the start permission signal to the engine starting device 130 (step S7). On the other hand, if the vehicle stopping time period is not within 1 hour, i.e., the vehicle stopping time period is longer than 1 hour (step S3; No), the test determining unit 127 determines that the test is necessary. Then, the test performing unit 128 sends the test signal for measuring the alcohol concentration to the alcohol sensor 110, and warns the driver to perform the test (step S4). When receiving the test signal from the test performing unit 128, the alcohol sensor 110 performs the test for measuring the driver's breath alcohol concentration, and sends the measurement result to the drunk driving control device 120.

The control unit 129 of the drunk driving control device 120 obtains the driver's breath alcohol concentration from the alcohol sensor 110 as the measurement result, and determines whether or not the alcohol concentration is equal to or higher than the predetermined threshold value (step S5). If the driver's breath alcohol concentration is lower than the threshold value (step S5; No), the control unit 129 sends the start permission signal to the engine starting device 130 (step S7). On the other hand, if the driver's breath alcohol concentration is equal to or higher than the threshold value (step S5; Yes), the control unit 129 sends the start inhibition signal to the engine starting device 130 (step S6). It is noted that, if the test is not performed because the driver does not accept the test and does not breath out to the alcohol sensor 110, the control unit 129 sends the start inhibition signal to the engine starting device 130. When receiving the start permission signal from the control unit 129, the engine starting device 130 starts the engine to start the vehicle. On the other hand, when receiving the start inhibition signal from the control unit 129, the engine starting device 130 does not start the vehicle by interrupting or stopping the supply of fuel or electric power to the engine. Thus, the drunk driving preventing process ends.

In the above embodiment, although the position data indicating the specific place where the test is omitted is stored as the criterion information, the present invention is not limited to this embodiment. The drunk driving preventing process may be executed after storing the position data indicating specific places where the test is necessary. The specific places where the test is necessary may be “a downtown area” or “a parking area near a bar”. Further, although the time when the possibility of drinking alcohol is highly is stored as the criterion information in the above embodiment, the present invention is not limited to this embodiment. The drunk driving preventing process may be executed after storing the time when the possibility of drinking alcohol is low.

In the above embodiment, although the drunk driving control device 120 obtains the vehicle stopped position data and the vehicle stopped time from the navigation apparatus 100 when the vehicle is stopped, the present invention is not limited to this embodiment. The drunk driving control device 120 may obtain the vehicle stopped position data and the vehicle stopped time when the vehicle enters a specific area or the vehicle goes out of a specific area.

In the above embodiment, although the vehicle stopped position data and the vehicle stopped time are stored in the memory of the drunk driving control device 120, the present invention is not limited to this embodiment. Those data may be stored in the RAM 24 by the navigation apparatus 100. In this case, when executing the drunk driving preventing process, the drunk driving control device 120 recognizes the vehicle stopped position data and the vehicle stopped time by referring to the RAM 24 of the navigation apparatus 100.

In the above embodiment, the alcohol concentration used as a criterion of determining whether or not the vehicle is started is preset as the threshold value, and the vehicle is not started when the driver's breath alcohol concentration is equal to or higher than the threshold value. However, the present invention is not limited to this embodiment. Regardless of the alcohol concentration, starting the vehicle may be inhibited when alcohol is detected in the vehicle.

In the above embodiment, all of the first to third methods, for determining the necessity of the test, are applied to the drunk driving preventing process. However, the present invention is not limited to this embodiment. Each one of, or any arbitrary combination of the first to third methods may be applied.

In the above embodiment, the drunk driving preventing apparatus 200 includes the engine starting device 130, and inhibits the start of the vehicle by interrupting or stopping the supply of fuel or electric power to the engine when alcohol is detected. However, the present invention is not limited to this embodiment. Any method of inhibiting the driving, e.g., locking the door not to open, may be applied.

In the above embodiment, the drunk driving preventing apparatus 200 includes the navigation apparatus 100 and obtains the position data and the present time from the navigation apparatus 100. However, the present invention is not limited to this embodiment. A mobile phone or a PDA (Personal Digital Assistant) having a GPS function may be connected to the drunk driving preventing apparatus 200 to obtain the position data and the present time from the mobile phone or the PDA. In this case, it is not necessary to always obtain the current position of the vehicle, and it is sufficient that the vehicle stopped position can be obtained when the vehicle is stopped.

In the above embodiment, although the alcohol sensor 110, the drunk driving control device 120 and the engine starting device 120 are formed as separate devices, the present invention is not limited to this embodiment. A single device having all of those functions may be used.

As described above, the drunk driving preventing apparatus 200 can perform the test of measuring the alcohol concentration, before driving the vehicle, when the possibility that the driver us drinking alcohol is high, and can inhibit the driving if the alcohol is detected. Specifically, the drunk driving preventing apparatus 200 determines whether or not to perform the test of measuring the alcohol concentration based on the vehicle stopped position, the present time and the vehicle stopping time period. Thus, the situation in which the test is doubtlessly unnecessary can be accurately determined, and unnecessary test can be omitted. Therefore, it is possible to make the driver, who does not like to breath out to the alcohol sensor 110 when he or she is not drinking alcohol, feel comfortable. In addition, when the driver is not drinking alcohol, the vehicle can be immediately started.

### Modified Example

Although the above embodiment does not mention, a plurality of alcohol sensors may be provided on the vehicle. It is noted that the description of the process similar to the above embodiment will be omitted for the sake of convenience.

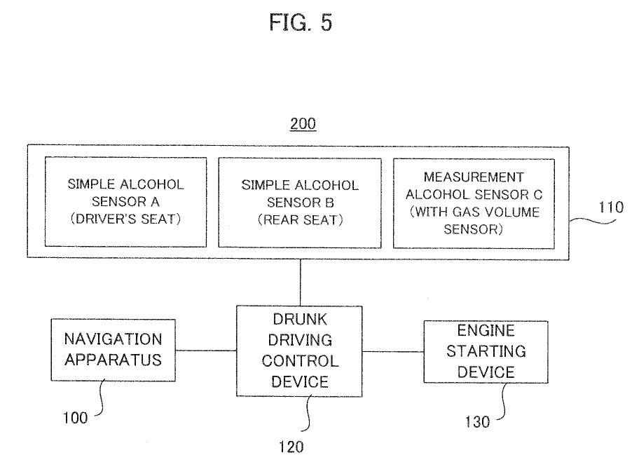

As shown in FIG. 5, the alcohol sensor 110 according to the modified embodiment includes simple alcohol sensors A and B installed at the driving seat and the rear seat of the vehicle, respectively, and capable of detecting alcohol, and a measurement alcohol sensor C installed at the driver's seat and capable of measuring the driver's breath alcohol concentration. Specifically, the simple alcohol sensor A and the measurement alcohol sensor C are installed around the headrest and/or the steering wheel of the driver's seat.

Although the kinds of the simple alcohol sensors A and B and the measurement alcohol sensor C are arbitrary, the simple alcohol sensors A and B according to the modified embodiment detects alcohol from the scent based on the air in the vehicle, and the measurement alcohol sensor C measures the alcohol concentration based on the breath of the driver. It is preferred that the measurement alcohol sensor C has a gas volume sensor so that the erroneous detection can be reduced.

As shown in FIG. 5, in case that the plurality of alcohol sensors are installed in the vehicle, when the simple alcohol sensors A and B detect alcohol, the test determining unit 127 of the drunk driving control device 120 determines whether or not to perform the test for measuring the alcohol concentration by the measurement alcohol sensor C, based on the place where the simple alcohol sensors A and B detect alcohol.

Specifically, the drunk driving control device 120 makes the simple alcohol sensors A and B detect alcohol near the driver's seat and the rear seat. Namely, the drunk driving control device 120 of the modified embodiment functions as the simple detecting means. Then, the test determining unit 127 of the drunk driving control device 120 determines whether or not the simple alcohol sensor B detects alcohol near the rear seat, when the simple alcohol sensor A detects alcohol near the driver's seat. If alcohol is not detected near the rear seat but is detected only near the driver's seat, the test determining unit 127 judges that it is highly possible the driver is drinking alcohol, and determines the test by the measurement alcohol sensor C is not necessary. Then, the control unit 129 sends the start inhibition signal to the engine starting device 130 without performing the test by the measurement alcohol sensor C.

On the other hand, if strong alcohol is detected near the rear seat by the simple alcohol sensor B and weak alcohol is detected near the driver's seat by the simple alcohol sensor A near the driver's seat, the test determining unit 127 judges that it is highly possible the drinking person in at the rear seat and the driver is not drinking alcohol, and determines the test by the measurement alcohol sensor C is necessary. Therefore, the test performing unit 128 sends the test signal to the measuring alcohol sensor C and warns the driver to perform the test. The measurement alcohol sensor 120 sends the driver's breath alcohol concentration to the drunk driving control device 120 as the measurement result, and the control unit 129 of the drunk driving control device 120 sends the start permission signal or the start inhibition signal to the engine starting device 130 based on the measurement result.

Although the alcohol sensors are installed at the driver's seat and the rear seat of the vehicle in this modified embodiment, the present invention is not limited to this embodiment. The installing position of the alcohol sensors may be arbitrarily determined, for example, at the driver's seat, the assistant driver's seat, the center seat or the rear seat.

As described above, when alcohol is detected in the vehicle by the simple alcohol sensor, the drunk driving preventing apparatus 200 according to the modified embodiment can determine whether or not to perform the test for measuring the alcohol concentration based on the position where alcohol is detected. Namely, based on the result of the plural alcohol sensors, the drunk driving preventing apparatus 200 can accurately determine whether or not to perform the test, in consideration of the drinking people at the rear seat.

In the embodiment and the modified embodiment, the drunk driving preventing apparatus 200 determines whether or not the driver is drinking alcohol by detecting alcohol in the driver's breath or the air in the vehicle. However, the present invention is not limited to this. A camera may be installed inside or outside of the vehicle, and the images captured by the camera may be used to discriminate each individual, to presume the drunk state by comparing the face picture with that of the normal situation, or to determine the sign of being drunk. Similarly, a microphone may be installed in the vehicle, and the captured voice may be used to presume the drunk state by comparing the voice with that of the normal situation, or to determine the sign of being drunk. Further, it may be possible to determine that the driving is drinking alcohol when the running vehicle largely strolls or deviates from the road, and the drunk driving control device 120 warns the driver to perform the test.

### INDUSTRIAL APPLICABILITY

This invention can be applied to a variety of vehicle as an apparatus for preventing the drunk driving.

1-11. (canceled)

12. A drunk driving preventing apparatus installed on a vehicle and including an alcohol sensor, comprising:
a test determining unit which determines whether or not to perform a test for detecting alcohol by the alcohol sensor, based on a predetermined condition, when the vehicle is started;
a test performing unit which performs the test by the alcohol sensor when the test determining unit determines to perform the test;
a control unit which disables driving operation of the vehicle when the test performing unit performs the test and alcohol is detected as a result of the test;
a specific time storing unit which stores a specific time; and
a present time obtaining unit which obtains a present time,
wherein the test determining unit determines whether or not to perform the test based on the present time obtained by the present time obtaining unit and the specific time stored by the specific time storing unit, when the vehicle is started.

13. The drunk driving preventing apparatus according to claim 12,
wherein the test performing unit performs the test by measuring an alcohol concentration by the alcohol sensor when the test determining unit determines to perform the test, and
wherein the control unit disables the driving operation of the vehicle when the test performing unit performs the test and the alcohol concentration measured by the alcohol sensor is equal to or higher than a predetermined threshold value.

14. The drunk driving preventing apparatus according to claim 13,
wherein the alcohol sensor includes: simple alcohol sensors installed at a driver's seat and a rear seat of the vehicle, respectively, and capable of detecting alcohol; and a measuring alcohol sensor installed at the driver's seat and capable of measuring an alcohol concentration,
the drunk driving preventing apparatus further comprising a simple detecting unit which detects alcohol near the driver's seat and alcohol near the rear seat, respectively, by the simple alcohol sensors,
wherein the test determining unit determines whether or not to perform the test based on a detection result of alcohol near the driver's seat and a detection result of alcohol near the rear seat by the simple alcohol sensors, and
wherein the test performing unit performs the test by measuring the alcohol concentration by the measuring alcohol sensor when the test determining unit determines to perform the test.

15. The drunk driving preventing apparatus according to claim 14, wherein the control unit disables the driving operation of the vehicle without performing the test by the test performing unit, when the simple detecting unit detects alcohol near the driver's seat and does not detect alcohol near the rear seat.

16. The drunk driving preventing apparatus according to claim 14, wherein the test determining unit determines to perform the test when the simple detecting unit detects weak alcohol near the driver's seat and detects strong alcohol near the rear seat.

17. A drunk driving preventing apparatus installed on a vehicle and including an alcohol sensor, comprising:
a test determining unit which determines whether or not to perform a test for detecting alcohol by the alcohol sensor, based on a predetermined condition, when the vehicle is started;
a test performing unit which performs the test by the alcohol sensor when the test determining unit determines to perform the test;
a control unit which disables driving operation of the vehicle when the test performing unit performs the test and alcohol is detected as a result of the test; a specific position storing unit which stores a position of a specific place; and
a vehicle stopped position obtaining unit which obtains a vehicle stopped position,
wherein the test determining unit determines whether or not to perform the test based on the vehicle stopped position obtained by the vehicle stopped position obtaining unit and the position of the specific place stored by the specific position storing unit, when the vehicle is started.

18. A drunk driving preventing apparatus installed on a vehicle and including an alcohol sensor, comprising:
a test determining unit which determines whether or not to perform a test for detecting alcohol by the alcohol sensor, based on a predetermined condition, when the vehicle is started;
a test performing unit which performs the test by the alcohol sensor when the test determining unit determines to perform the test;
a control unit which disables driving operation of the vehicle when the test performing unit performs the test and alcohol is detected as a result of the test;
a vehicle stopped time storing unit which stores a vehicle stopped time; and
a vehicle stopping time period determining unit which determines a vehicle stopping time period by calculating a difference between the present time obtained by the present time obtaining unit and the vehicle stopped time stored by the vehicle stopped time storing unit,
wherein the test determining unit determines whether or not to perform the test if the vehicle stopping time period determined by the vehicle stopping time period determining unit is equal to or longer than a predetermined time period, when the vehicle is started.

19. A drunk driving preventing method executed by a drunk driving preventing apparatus installed on a vehicle and including an alcohol sensor, comprising:
a test determining process which determines whether or not to perform a test for detecting alcohol by the alcohol sensor, based on a predetermined condition, when the vehicle is started;
a test performing process which performs the test by the alcohol sensor when the test determining process determines to perform the test;
a control process which disables driving operation of the vehicle when the test performing process performs the test and alcohol is detected as a result of the test;
a specific time storing process which stores a specific time; and
a present time obtaining process which obtains a present time,
wherein the test determining process determines whether or not to perform the test based on the present time obtained by the present time obtaining process and the specific time stored by the specific time storing process, when the vehicle is started.

20. A computer program product in a computer-readable medium for preventing drunk driving, which is executed by a computer installed on a vehicle and including an alcohol sensor, and which makes the computer function as:
a test determining unit which determines whether or not to perform a test for detecting alcohol by the alcohol sensor, based on a predetermined condition, when the vehicle is started;
a test performing unit which performs the test by the alcohol sensor when the test determining unit determines to perform the test;
a control unit which disables driving operation of the vehicle when the test performing unit performs the test and alcohol is detected as a result of the test;
a specific time storing unit which stores a specific time; and
a present time obtaining unit which obtains a present time,
wherein the test determining unit determines whether or not to perform the test based on the present time obtained by the present time obtaining unit and the specific time stored by the specific time storing unit, when the vehicle is started.
